(19) United States
(12) Patent Application Publication
(10) Pub. No.: US 2021/0188193 A1
(43) Pub. Date: Jun. 24, 2021

(54) VEHICLE INTERIOR TRIM PART FORMED WITH INTERGRATED ELECTRONICS AND METHOD OF MAKING

(71) Applicant: Inteva Products, LLC, Troy, MI (US)

(72) Inventors: David Whitehead, Rochester Hills, MI (US); Thomas Sybrandy, Washington, MI (US); Aidano Nascimento, Oakland Township, MI (US); Tyler Bame, Clawson, MI (US); David Kovac, Warren, MI (US)

(21) Appl. No.: 17/121,383

(22) Filed: Dec. 14, 2020

Related U.S. Application Data
(60) Provisional application No. 62/953,317, filed on Dec. 24, 2019.

(51) Int. Cl. B60R 13/02; B29C 45/14; B60R 16/023

(52) U.S. Cl. CPC B60R 13/02; B29L 2031/3008; B60R 16/023; B29C 45/14467

(57) ABSTRACT

An assembly, the assembly including: a substrate; an injection molded structural electronic component; and a layer of polymer that partially encapsulates the substrate and the injection molded structural electronic component and unifies the substrate and the injection molded structural electronic component into one component.

### CROSS-REFERENCE TO RELATED APPLICATIONS

This application claims the benefit of Application No. 62/953,317 filed on Dec. 24, 2019, the contents of which are incorporated herein by reference thereto.

### BACKGROUND

Exemplary embodiments of the present disclosure pertain to vehicle interior trim parts and more particularly, a vehicle interior trim part formed with integrated electronics.

Injection molded structural electronics are unique standalone parts. However and when multiple electronic components are desired to be used in a single application, multiple separate pieces have to be fit together on a carrier frame. This leads to increased package requirements and the management of multiple fit requirements. Alternatively, one single injection molded structural electronic with numerous components is cost prohibitive and difficult to change.

Accordingly, it is desirable to provide a vehicle interior trim part formed with integrated electronics.

### BRIEF DESCRIPTION

Disclosed is an, the assembly including: a substrate; an injection molded structural electronic component; and a layer of polymer that partially encapsulates the substrate and the injection molded structural electronic component and unifies the substrate and the injection molded structural electronic component into one component.

In addition to one or more of the features described above, or as an alternative to any of the foregoing embodiments, the assembly includes another injection molded structural electronic component.

In addition to one or more of the features described above, or as an alternative to any of the foregoing embodiments, the assembly includes alternative electronics.

In addition to one or more of the features described above, or as an alternative to any of the foregoing embodiments, the injection molded structural electronic component has a cut out portion that is configured to receive the alternative electronics.

In addition to one or more of the features described above, or as an alternative to any of the foregoing embodiments, the assembly is a portion of a vehicle interior.

In addition to one or more of the features described above, or as an alternative to any of the foregoing embodiments, the assembly includes a plurality of icons.

Also disclosed is a method for providing an assembly, the method including the steps of: forming an injection molded substrate; forming at least one injection molded structural electronic component; placing the injection molded substrate and the at least one injection molded structural electronic component in a tool; and partially overmolding the injection molded substrate and the at least one injection molded structural electronic component with a polymer injected into the tool; and unifying the injection molded substrate and the at least one injection molded structural electronic component into one component with the polymer.

In addition to one or more of the features described above, or as an alternative to any of the foregoing embodiments, another injection molded structural electronic component is placed in the tool prior to the partially overmolding step.

In addition to one or more of the features described above, or as an alternative to any of the foregoing embodiments, alternative electronics are inserted into the tool.

In addition to one or more of the features described above, or as an alternative to any of the foregoing embodiments, at least one injection molded structural electronic component has a cut out portion that is configured to receive alternative electronics.

In addition to one or more of the features described above, or as an alternative to any of the foregoing embodiments, the assembly is a portion of a vehicle interior.

In addition to one or more of the features described above, or as an alternative to any of the foregoing embodiments, the assembly includes a plurality of icons.

### BRIEF DESCRIPTION OF THE DRAWINGS

The following descriptions should not be considered limiting in any way. With reference to the accompanying drawings, like elements are numbered alike:

FIG. 1 is portion of a vehicle interior with a plurality of icons corresponding to a plurality of non-moving switches that are illuminated in accordance with an embodiment of the present disclosure;

FIG. 2 is portion of the vehicle interior of FIG. 1 wherein the plurality of icons corresponding to the plurality of non-moving switches are no longer illuminated in accordance with an embodiment of the present disclosure;

FIG. 3 is exploded view of a portion of a vehicle interior component formed in accordance with an embodiment of the present disclosure;

FIG. 4 is a perspective view of a portion of a vehicle interior component formed in accordance with an embodiment of the present disclosure; and

FIG. 5 is a flow chart illustrating a method for making a component or assembly in accordance with embodiments of the present disclosure.

### DETAILED DESCRIPTION

A detailed description of one or more embodiments of the disclosed apparatus and method are presented herein by way of exemplification and not limitation with reference to the Figures.

In accordance with the present disclosure, an insert molding process is used to incorporate multiple injection molded structural electronic (IMSE) parts or other electronic parts into one component. Injection molded structural electronics use multiple printed film layers and injected polymer between layers to provide the injection molded structural electronic (IMSE) part.

In accordance with the present disclosure, several electronic components such as an injection molded structural electronic (IMSE) part are located in an injection mold. In one embodiment, at least one injection molded structural electronic (IMSE) part is placed in the injection mold. In yet another embodiment, at least one injection molded structural electronic (IMSE) part is placed in the injection mold in addition to another electronic part.

Once the part or parts are inserted into the injection mold a polymer is injected into the tool that partially encapsulates the parts in the tool and unifies those parts into one component.

In another exemplary embodiment of the invention a substrate is created in a first injection molding shot, and components are added to this substrate. Once the parts are joined, a third material is molded over the sub-assembly creating a unified structure.

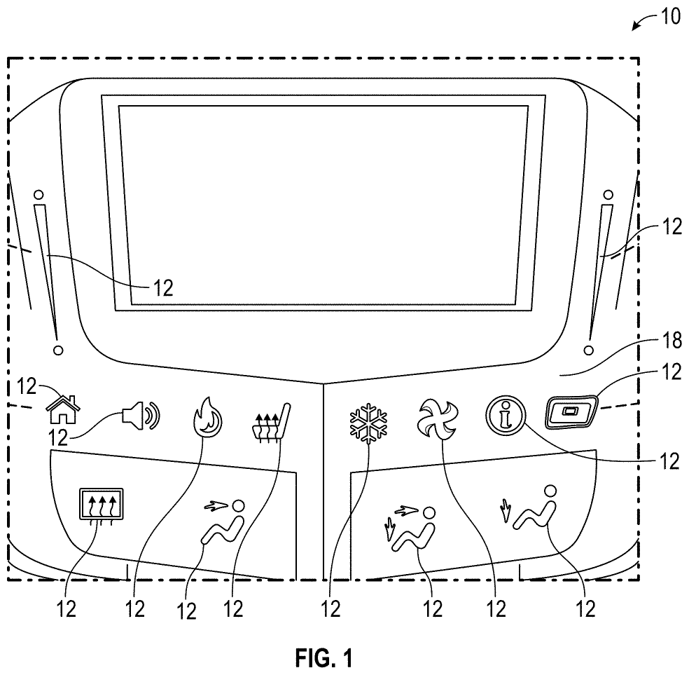

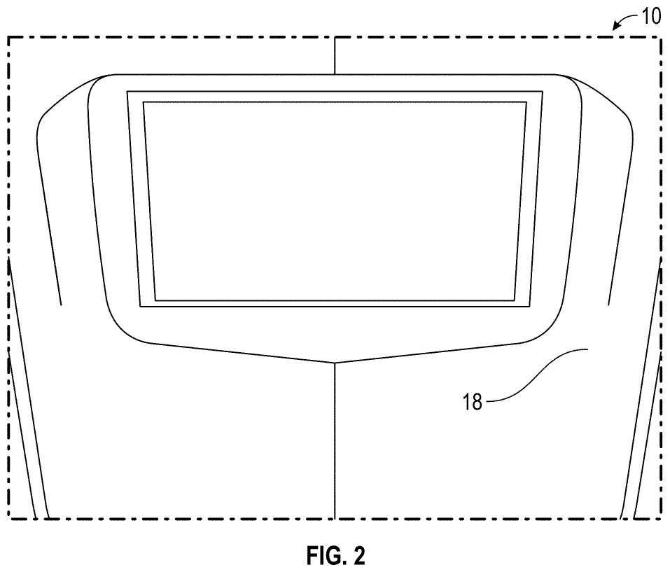

Referring now to FIG. 1 a portion 10 of a vehicle interior with a plurality of icons 12 corresponding to a plurality of non-moving switches that are illuminated in accordance with an embodiment of the present disclosure is illustrated. In FIG. 2, the portion 10 of the vehicle interior is no longer illuminated and the plurality of icons corresponding to the plurality of non-moving switches are no longer illuminated. In one embodiment, the icons 12 may be formed as three dimensional icon or icons in the layer of material defining the show surface of the portion 10.

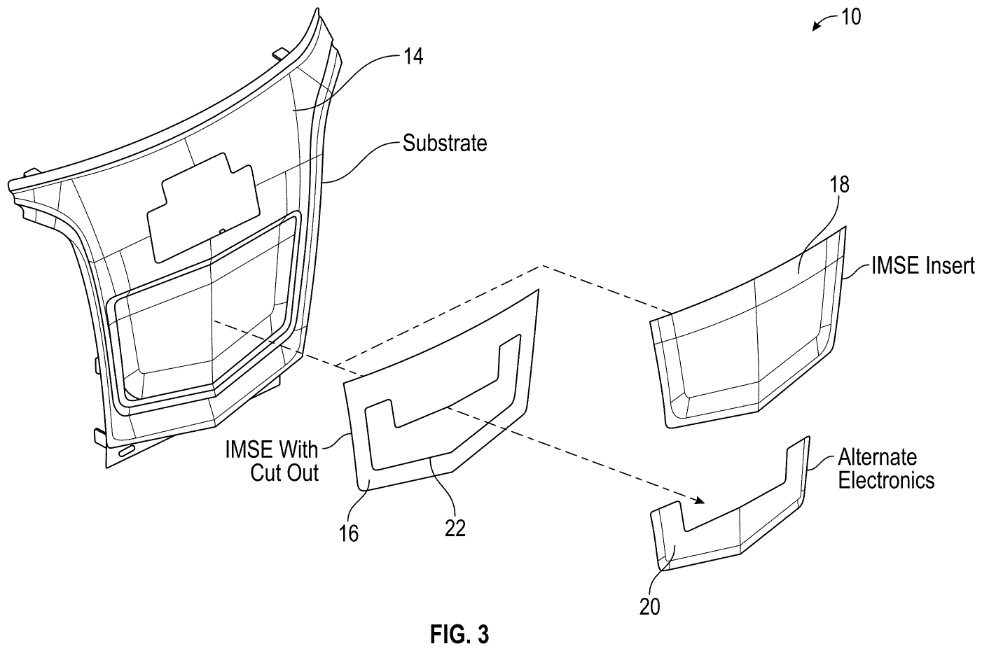

FIG. 3 is an exploded view of the portion 10 of a vehicle interior component. In one embodiment, the portion of the vehicle interior may be similar to the portion illustrated in FIGS. 1 and 2. This portion 10 may also be referred to as an assembly 10 or component 10 or interior trim 10 of a vehicle. As illustrated, a substrate 14 that is created in a first injection molding shot is provided. Also illustrated is a first injection molded structural electronic (IMSE) part 16 and a second injection molded structural electronic (IMSE) part 18. As mentioned above, the first injection molded structural electronic (IMSE) part 16 and the second injection molded structural electronic (IMSE) part 18 as well as the substrate are formed by injection molding processes. In addition, alternative electronics 20 may also be provided. In one non-limiting embodiment, the first injection molded structural electronic (IMSE) part 16 has a cut out portion 22 that is configured to receive the alternative electronics 20.

Once these part or parts are inserted into the injection mold a polymer is injected into the tool that partially encapsulates the parts in the tool and unifies those parts into one component.

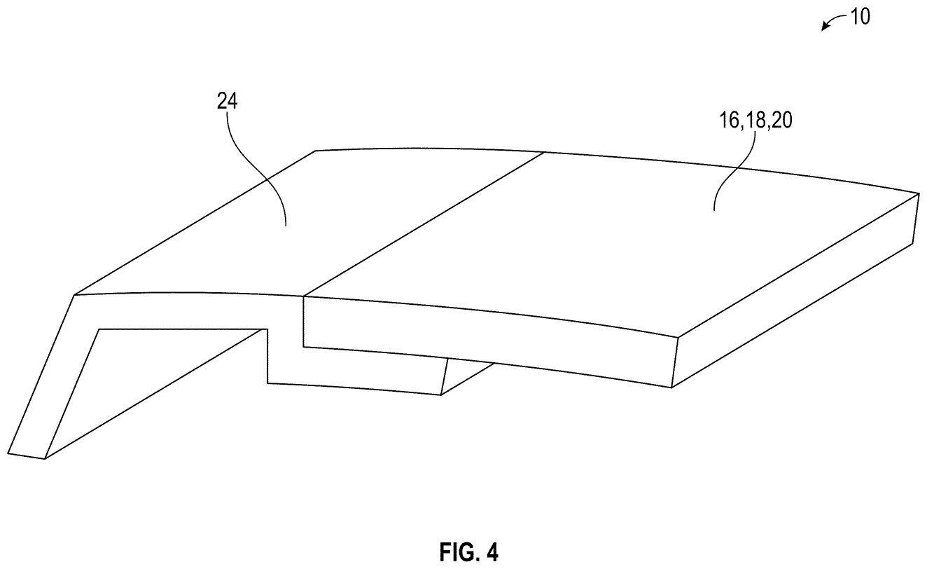

FIG. 4 is a perspective view of a portion of a vehicle interior component formed in accordance with an embodiment of the present disclosure. Here one of the electronic parts 16, 18 and 20 are illustrated and a portion 24 of the assembly 10 or component 10 or interior trim 10 formed by the injected polymer is illustrated.

As mentioned above, the injection molded structural electronic components 16, 18 comprises multiple printed film layers and injected polymer between layers, which will include a non-contact sensor or switch such as a capacitive switch that corresponds to a respective icon 12. In one embodiment, the injection molded structural electronic component 16, 18 may also comprise a means for illuminating the icons 12. In one embodiment, the means for illuminating or illuminating device may be a light emitting diode.

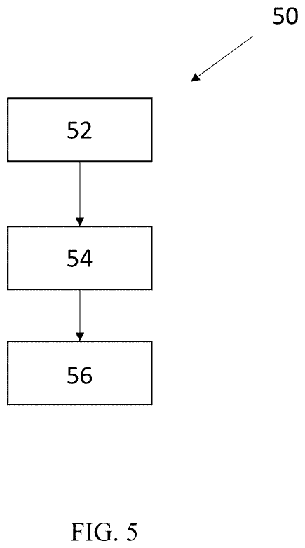

Referring now to FIG. 5 a flow chart 50 is provided for illustrating a method for making a component 10 or assembly 10 in accordance with embodiments of the present disclosure. In a first step 52, an injection molded substrate 14 and at least one injection molded structural electronic component 16, 18 and an alternative electronic 20 are formed. Thereafter and in a second step 54, the injection molded substrate 14, the at least one injection molded structural electronic component 16, 18 and, if desired, an alternative electronic 20 are placed in a tool. Thereafter and in a third step 56, the injection molded substrate 14, the at least one injection molded structural electronic component 16, 18 and, if desired, an alternative electronic 20 are partially overmolded with a polymer injected into the tool such that the polymer partially encapsulates the parts in the tool and unifies those parts into one component.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An assembly, comprising:
a substrate;
an injection molded structural electronic component; and
a layer of polymer that partially encapsulates the substrate and the injection molded structural electronic component and unifies the substrate and the injection molded structural electronic component into one component.

2. The assembly as in claim 1, further comprising another injection molded structural electronic component.

3. The assembly as in claim 1, further comprising alternative electronics.

4. The assembly as in claim 3, wherein the injection molded structural electronic component has a cut out portion that is configured to receive the alternative electronics.

5. The assembly as in claim 1, wherein the assembly is a portion of a vehicle interior.

6. The assembly as in claim 1, wherein the assembly comprises a plurality of icons.

7. A method for providing an assembly, comprising:
forming an injection molded substrate;
forming at least one injection molded structural electronic component;
placing the injection molded substrate and the at least one injection molded structural electronic component in a tool; and
partially overmolding the injection molded substrate and the at least one injection molded structural electronic component with a polymer injected into the tool; and
unifying the injection molded substrate and the at least one injection molded structural electronic component into one component with the polymer.

8. The method as in claim 7, wherein another injection molded structural electronic component is placed in the tool prior to the partially overmolding step.

9. The method as in claim 7, wherein alternative electronics are inserted into the tool.

10. The method as in claim 9, wherein the at least one injection molded structural electronic component has a cut out portion that is configured to receive the alternative electronics.

11. The method as in claim 7, wherein the assembly is a portion of a vehicle interior.

12. The method as in claim 7, wherein the assembly comprises a plurality of icons.
